(19) United States
(12) Patent Application Publication
(10) Pub. No.: US 2023/0321856 A1
(43) Pub. Date: Oct. 12, 2023

(54) Insulated Wall Panels & Turcotte Sculptor

(71) Applicant: Michael S. Turcotte, Cudjoe Key, FL (US)

(72) Inventor: Michael S. Turcotte, Cudjoe Key, FL (US)

(73) Assignee: Michael S. Turcotte, Cudjoe Key, FL (US)

(21) Appl. No.: 18/187,022

(22) Filed: Mar. 21, 2023

Related U.S. Application Data
(60) Provisional application No. 63/322,258, filed on Mar. 22, 2022.

(51) Int. Cl. B26F 3/12; B26D 3/00; B26D 5/00

(52) U.S. Cl. CPC B26D 3/006; B26D 5/005; B26F 3/12; E04C 2/10

(57) ABSTRACT

Insulated, load bearing wall panels are machined from a raw foam slab of foam material. The raw foam slab is loaded into a Turcotte sculptor. The Turcotte sculptor is an elegant 36-axis machine that machines the raw foam slab into one or more insulated foam wall panels. The Turcotte sculptor, in particular, may accept very large 18x4x2 feet slabs of foam material. The Turcotte sculptor then individually commands and actuates any of 36 linear actuators to produce the one or more insulated foam wall panels. The Turcotte sculptor, within minutes, simultaneously machines the raw 18x4x2 foam slab into two (2) 9-feet tall wall panels for 9-feet ceilings. The Turcotte sculptor may easily machine other wall sizes. The Turcotte sculptor thus efficiently and quickly volume produces entire one-piece, single-height insulated wall panels at reduced cost and with outstanding energy performance.

### CROSS-REFERENCE TO RELATED APPLICATION

This patent application claims domestic benefit of U.S. Provisional Application No. 63/322,258 filed Mar. 22, 2022 and incorporated herein by reference in its entirety.

### BACKGROUND

The subject matter described herein generally relates to building materials and, more particularly, the subject matter relates to volume production of insulated wall panels.

Insulated wall panels are revolutionizing the building industry. Conventional walls and roofs are framed from steel or wood and then insulated. Typically, fiberglass insulation batts are installed, but lately foam insulation is sprayed between studs. Spray foam insulation, however, is laborious and expensive. Moreover, if the foam insulation is sprayed too thin, moisture and mold problems develop.

### SUMMARY

Insulated, load bearing wall panels are machined from a raw foam slab of foam material. The raw foam slab is loaded into a Turcotte sculptor. The Turcotte sculptor is an elegant 36-axis machine that machines the raw foam slab into one or more insulated foam wall panels. The Turcotte sculptor, in particular, may accept very large 18x4x2 feet slabs of foam material. The Turcotte sculptor then individually commands and actuates any of 36 linear actuators to produce the one or more insulated foam wall panels. The Turcotte sculptor, within minutes, simultaneously machines the raw 18x4x2 foam slab into two (2) 9-feet tall wall panels for 9-feet ceilings. The Turcotte sculptor may easily machine other wall sizes. Indeed, because the Turcotte sculptor may accept 18x4x2 feet slabs, or even larger, The Turcotte sculptor thus efficiently and quickly volume produces entire single-height insulated wall panels at reduced cost and with outstanding energy performance. Indeed, because the Turcotte sculptor is capable of machining very thick foam slabs, the Turcotte sculptor volume produces exceptionally-energy efficient wall panels having R-50 or greater insulative qualities.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

The features, aspects, and advantages of cloud services malware detection are understood when the following Detailed Description is read with reference to the accompanying drawings, wherein:

FIG. 1 illustrates some examples of a composite building panel;

FIG. 2 illustrates a simple, exploded view of the composite building panel;

FIG. 3 illustrates simple handling examples for the composite building panel;

FIGS. 4-5 illustrate simple installation examples for the composite building panel;

FIGS. 6-8 illustrate multiple installations of the composite building panels;

FIGS. 9-10 illustrate simple machining examples using a Turcotte sculptor;

FIGS. 11-15 illustrate orthographic and isometric examples of the finished machined foam core;

FIGS. 16-18 illustrate examples of a hot-wire cutting system;

FIGS. 19-22 illustrate examples for volume production; and

FIG. 23 illustrates examples of a method or flow chart for machining a raw foam slab using the Turcotte sculptor.

### DETAILED DESCRIPTION

Insulated, load bearing wall panels are machined from a raw foam slab of foam material. The raw foam slab is loaded into a Turcotte sculptor. The Turcotte sculptor is an elegant 36-axis machine that machines the raw foam slab into one or more insulated foam wall panels. The Turcotte sculptor, in particular, may accept very large 18x4x2 feet slabs of foam material. The Turcotte sculptor then individually commands and actuates any of 36 linear actuators to produce the one or more insulated foam wall panels. The Turcotte sculptor, within minutes, simultaneously machines the raw 18x4x2 foam slab into two (2) 9-feet tall wall panels for 9-feet ceilings. The Turcotte sculptor may easily machine other wall sizes. The Turcotte sculptor thus efficiently and quickly volume produces entire single-height insulated wall panels at reduced cost and with outstanding energy performance.

Insulated, load bearing wall panels and the Turcotte sculptor will now be described more fully hereinafter with reference to the accompanying drawings. The insulated wall panels and the Turcotte sculptor, however, may be embodied in many different forms and should not be construed as limited to the examples set forth herein. These examples are provided so that this disclosure will be thorough and complete and fully convey cloud-delivered hooking services to those of ordinary skill in the art. Moreover, all the examples are intended to encompass both structural and functional equivalents thereof. Additionally, it is intended that such equivalents include both currently known equivalents as well as equivalents developed in the future (i.e., any elements developed that perform the same function, regardless of structure).

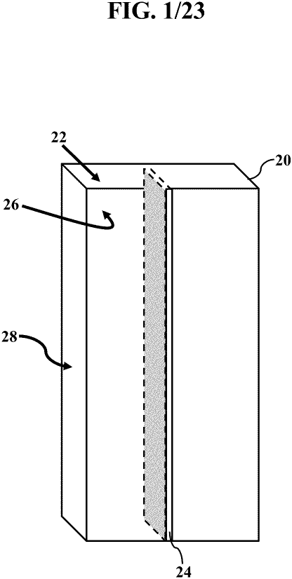

FIG. 1 illustrates some examples of a composite building panel 20. The composite building panel 20 is used to create walls, floors, roofs, ceilings, and other elements in building structures. The composite building panel 20 is formed of a load-bearing machined foam core 22. Because the machined foam core 22 is structurally load bearing, the composite building panel 20 may or may not include an alignment member 24. The alignment member 24 may also be load bearing. FIG. 1, for simplicity, illustrates only a single alignment member 24. The composite building panel 20, though, may not require any (none or zero) alignment members 24, depending on the density and compressive strength of the composite building panel 20 and roof/wall/floor loads. Multiple alignment members 24 may also be required, perhaps again due to loading. The alignment members 24 allow adjacent composite building panels 20 to be installed and interlocked, thus producing straight and tall insulated walls. While the composite building panel 20 may have any outer or exterior planar or curvilinear shape, FIG. 1 illustrates a rectangular outer shape 26. While the composite building panel 20 may have any interior cross-sectional shape, FIG. 1 illustrates a rectangular cross section 28. FIG. 1 thus illustrates the composite building panel 20 having a common shape for use in commercial and residential building construction.

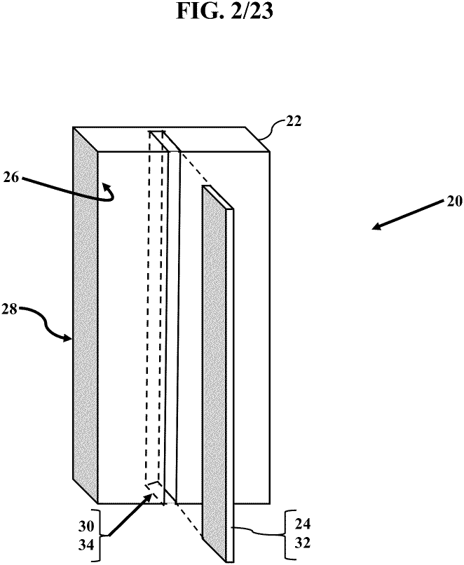

FIG. 2 illustrates a simple, exploded view of the composite building panel 20. The alignment member 24 inserts into a corresponding channel 30 machined into the machined foam core 22. The channel 30 is sized to accept its corresponding alignment member 24. FIG. 2 again illustrates simple examples having only one (2) channel 30 and thus one (1) corresponding alignment member 24. In actual practice, though, the composite building panel 20 may have no need for the alignment member 24, so no need for the channel 30 (based on loading). The composite building panel 20, though, may have a greater number (two or more) alignment members 24 and their corresponding channels 30. The number of the alignment members 24 and their corresponding channels 30 may be dictated by loads, wall height, alignment precision, cost, and other factors. In general, then, the composite building panel 20 has each channel 30 machined to fit the outer/exterior dimensions of its corresponding alignment member 24. In FIG. 2, for example, the alignment member 24 has a rectangular outer shape 32, so the channel 30 has a similarly sized rectangular inner shape 34 (e.g., width, depth, and length). The alignment member 24, though, may have a circular outer shape, so the corresponding channel 30 may have a similarly-sized concave inner shape (e.g., diameter/radius, depth, and length). Each alignment member 24 may thus be largely or mostly embedded or encased within its corresponding channel 30. The channel 30 may thus have a machined width and a recessed depth that exposes a side of the alignment member 24, thus allowing visual inspection and location of the alignment member 24 during installation/erection. The examples, though, may have the alignment member 24 entirely encapsulated/enclosed within an interior portion of the machined foam core 22 (thus making the alignment member 24 mostly hidden from view during installation/erection).

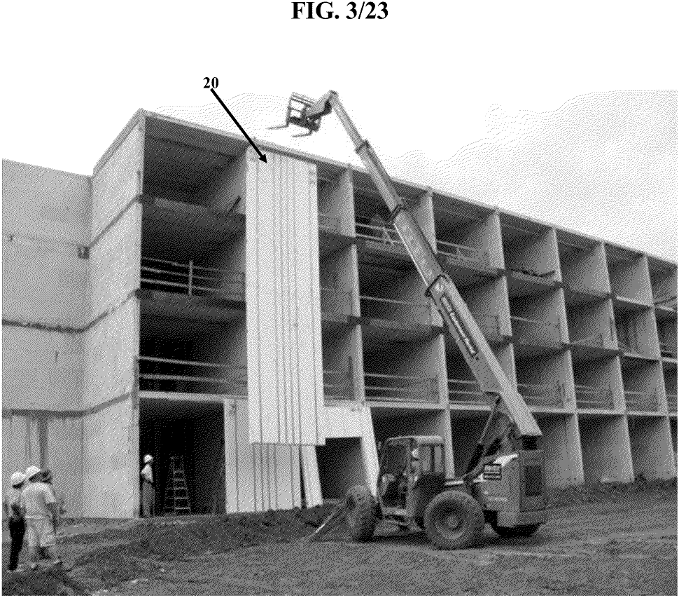

FIG. 3 illustrates simple handling examples for the composite building panel 20. Because the composite building panel 20 may be machined with long lengths (such as 18 feet, as later paragraphs will explain), the composite building panel 20 may be delivered to the job site and easily installed. Smaller-sized composite building panel 20 may be lifted and placed by hand. A larger-sized composite building panel 20, as FIG. 3 illustrates, may be lifted/hoisted using machinery and placed to the desired location.

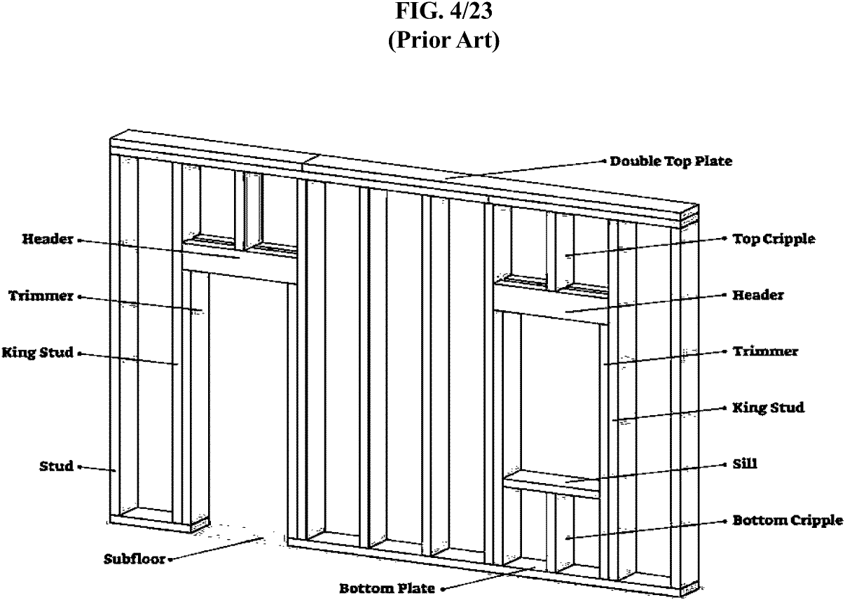

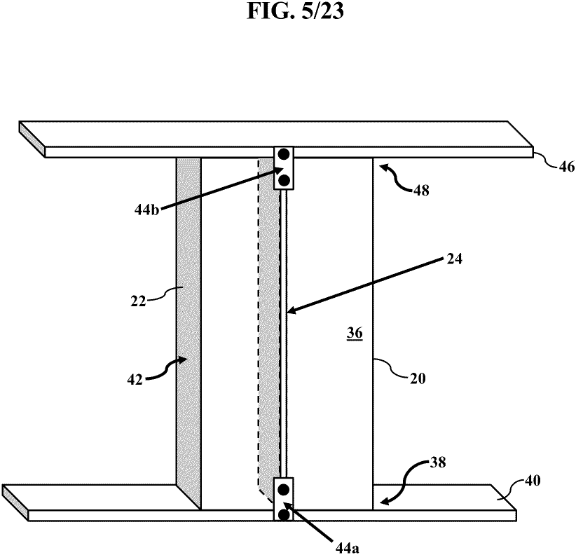

FIGS. 4-5 illustrate simple installation examples for the composite building panel 20. FIG. 4 illustrates common terms for conventional stud wall construction, which may be helpful for the reader. FIG. 5 illustrates interior securement of the composite building panel 20. That is, the composite building panel 20 may be installed with its exposed alignment member 24 oriented inward within a building’s interior space. The composite building panel 20 thus has an interior side 36 that may be secured along a bottom edge 38. A bottom floor plate 40 is secured to a floor (not shown for simplicity). While the floor plate 40 may have any shape and be constructed from any material, 2x wood construction is perhaps most common. The floor plate 40 may thus a 2x4, 2x6, 2x8, or other size of pressure-treated wood that approximately matches the material thickness 42 of the composite building panel 20. The floor plate 40 is typically secured to the floor along a perimeter of the building envelop for interior/exterior walls. The composite building panel 20 is then erected, lowered, and/or placed on top of the floor plate 40. One or more brackets 44a may then be screwed, bolted, or adhered between the bottom edge 38 and the floor plate 40. FIG. 5 illustrates the bracket 44a secured to a bottom portion of the alignment member 20. The composite building panel 20 may thus be simply, quickly, and securely installed. However the composite building panel 20 is secured to the floor plate 40, mechanical fasteners and/or adhesives may be used to secure the bottom edge 38 of the composite building panel 20 to the floor plate 40.

FIG. 5 also illustrates upper securement. A top plate 46 is secured to along a top side 48 of the composite building panel 20. Again, while the top plate 46 may have any shape and be constructed from any material, 2x wood construction is perhaps most common. The top plate 46 may thus a 2x4, 2x6, 2x8, or other size of pressure-treated wood that approximately matches the material thickness 42 of the composite building panel 20. The top plate 46 is placed along the top side 48 of the composite building panel 20. In actual practice, the top plate 46 is long enough to span two or more adjacent composite building panels 20 to ensure plumb alignment. One or more upper brackets 44b may then be screwed, bolted, or adhered to both the top side 48 and the top plate 46. The composite building panel 20 may thus be simply, quickly, and securely installed. Mechanical fasteners and/or adhesives may be used to secure the composite building panel 20 to the top plate 46.

The composite building panel 20 may also be exteriorly secured. Because the floor plate 40 is installed along the perimeter of the building envelope, the composite building panel 20 may additionally or alternatively be secured along an exterior side (perhaps again using the lower brackets 44a and mechanical fasteners and adhesives) to the floor plate 40. The composite building panel 20 may similarly be secured along the exterior side to the top plate 46.

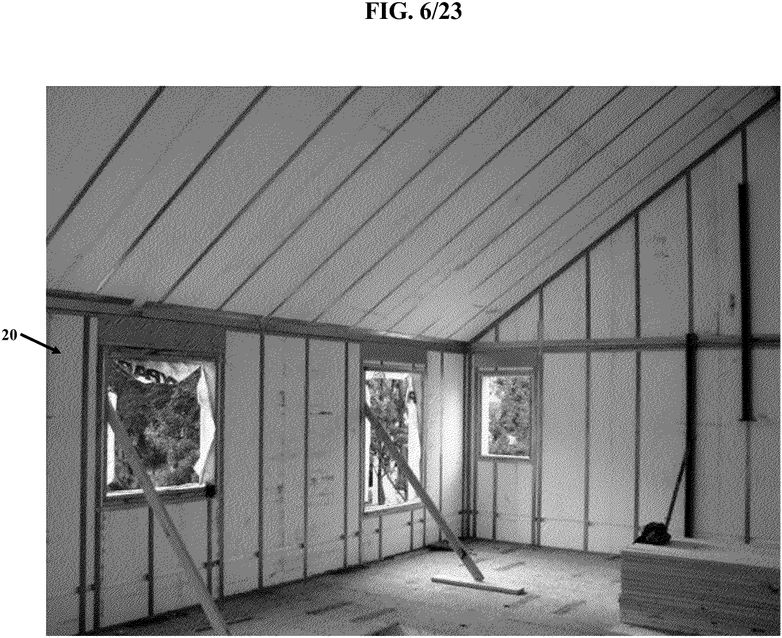

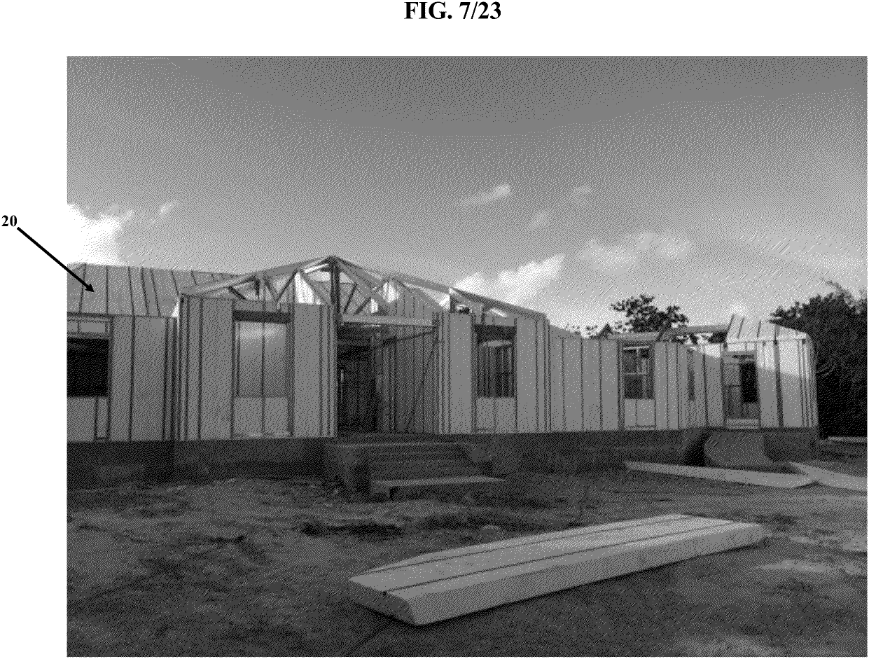

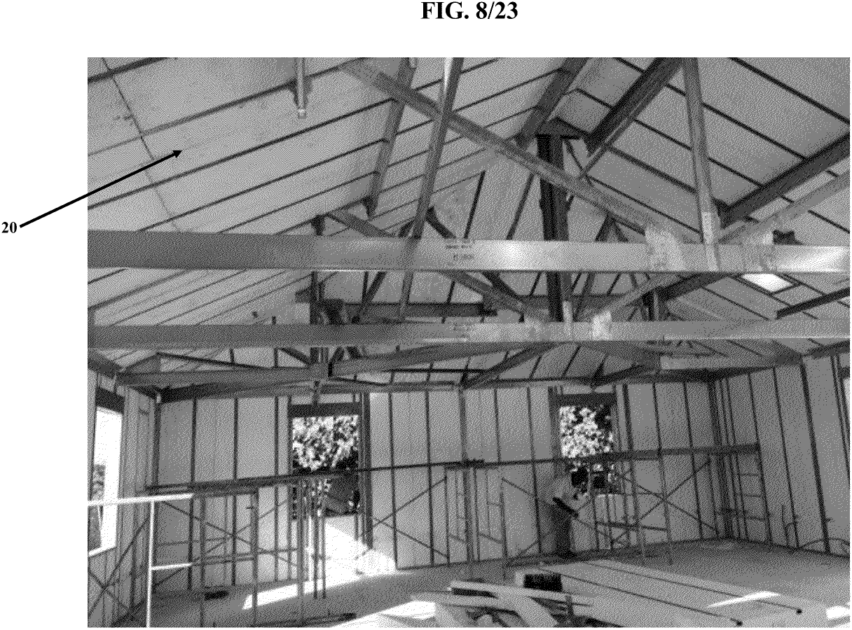

FIGS. 6-8 illustrate multiple installations of the composite building panels 20. Each composite building panel 20 is lowered into place and secured (perhaps to the floor plate explained with reference to FIGS. 4-5). An entire building wall is thus constructed as a linear alignment of multiple composite building panels 20. Spray foam insulation and/or spray adhesives may then be injected between adjacent composite building panels 20 to ensure lateral alignment, stability, and securement. Each composite building panel 20 is sized in width to ensure that the entire building wall substantially matches a total length specified by a construction drawing. Moreover, each composite building panel 20 is sized in height to also ensure that the entire building wall is uniform and substantially matches a wall height specified by the construction drawing. The composite building panels 20 are repeatedly installed, perhaps in numerical series, until all the exterior walls of the building are formed. Moreover, FIGS. 6-8 illustrate illustrates additional roofing installations. Ceilings and roofs also require high insulative properties, and the composite building panels 20 may be incorporated into ceiling and roof designs. As a simple example, the composite building panels 20 may be laid atop the top chords of roof trusses (as FIG. 6 illustrates) for superior insulation, sound proofing, and water shedding. The composite building panels 20 may also be secured to the bottom chords of roof and floor trusses for the same superior insulation, sound proofing, and water shedding. The composite building panel 20 is simply a superior product.

Window and door openings may also be cut. The examples describe the machined channel(s) 30 for the corresponding alignment member(s) 24. The machined foam core 22, though, may also be cut or sculpted to further include cutouts for windows and doors (as FIG. 6 illustrates). Indeed, the machined foam core 22 may be cut to include cutouts for headers and sills.

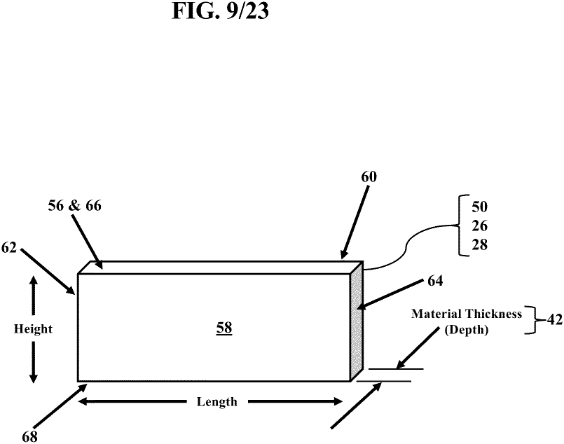

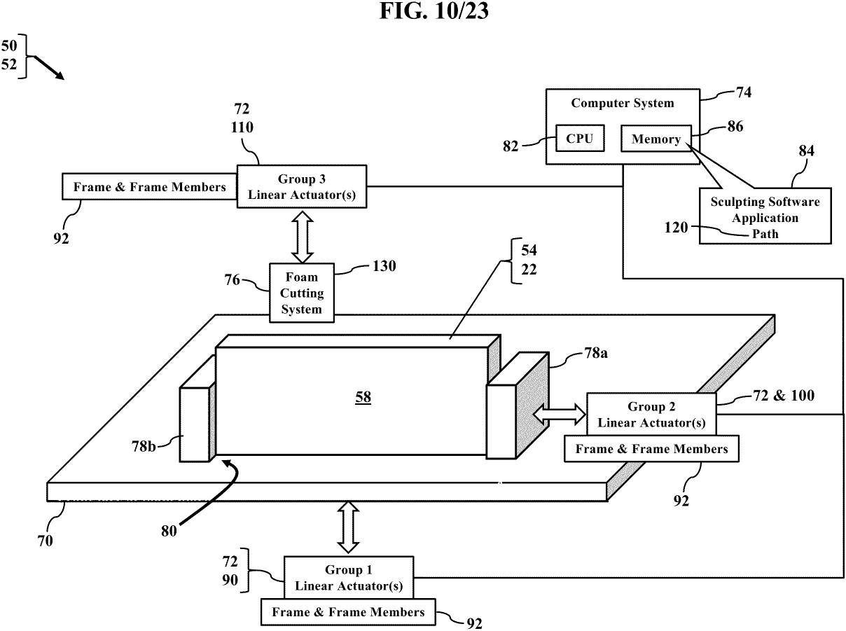

FIGS. 9-10 illustrate simple machining examples using a Turcotte sculptor 50. The Turcotte sculptor 50 is an elegant 36-axis machine 52 that machines a raw slab 54 of foam material 56 to produce the machined foam core 22. FIG. 9 first illustrates the raw slab 54 of the foam material 56. While the raw slab 54 may have any shape, FIG. 9 illustrates the rectangular outer shape 26 and the rectangular cross section 28. Moreover, because the raw slab 54 is sized for wall sections, the raw slab 54 is a large and thick hunk of the foam material 56. For example, the Turcotte sculptor 50 is sized to machine raw slabs 50 of at least 18x4x2 feet, which are currently the largest sizes available to the inventor’s knowledge. As larger-sized slabs 50 become available in production quantities, the Turcotte sculptor 50 may be easily upsized. The raw slab 54 may thus have a front side 58, an opposite back side 60, left/right sides 62 and 64, and top/bottom sides 66 and 68.

While any foam material 56 may be used, the examples will mostly be described as expanded polystyrene (or EPS) foam material. EPS is 90% air, so the machined foam core 22 has superb insulative qualities. EPS has a relatively high compressive strength, so the machined foam core 22 is a structural load bearing member. EPS is water resistant, so the machined foam core 22 does not retain moisture and resists mildew and mold. Indeed, because EPS is water resistant, the machined foam core 22 acts as a vapor barrier to moisture. Just as important, EPS is composed of organic elements (e.g., carbon, hydrogen and oxygen), so EPS does not contain chlorofluorocarbons (CFCs) or hydrochlorofluorocarbons (HCFCs). The machined foam core 22 is thus an environmentally green product that has superior performance characteristics.

FIG. 10 illustrates a simple slab diagram of the Turcotte sculptor 50. The Turcotte sculptor 50 is the elegant 36-axis machine 52 that machines the raw slab 54 to produce the machined foam core 22. That is, the single raw slab 54 of the foam material 56 is loaded onto a table 70 associated with the Turcotte sculptor 50. The Turcotte sculptor 50 is an automated, computer-controlled foam sculpting machine having thirty six (36) linear actuators 72. The Turcotte sculptor 50 has a computer system 74 that communicates via a communications network (not shown for simplicity) with any of the thirty six (36) linear actuators 72. The computer system 74 may thus control movements of the table 70. The computer system 74 may also control movements of a foam cutting system 76 and/or of one or more alignment fences 78. By controlling the movements of the table 70, the foam cutting system 76, and/or the fence(s) 78, the Turcotte sculptor 50 automatically machines the single raw slab 54 of the foam material 56 into the finished machined foam core 22. The Turcotte sculptor 50, for example, automatically aligns the single raw slab 54 of the foam material 56 to a zero origin or start position 80. Once the single raw slab 54 of the foam material 56 is aligned to the zero origin position 80, then the Turcotte sculptor 50 cuts the single raw slab 54 of the foam material 56 to its required height, width, and/or thickness (specified by the construction drawing). The Turcotte sculptor 50 also cuts the one or more channels 30 at their required width, depth, and length (as specified by the construction drawing). The Turcotte sculptor 50 may also automatically remove or extract any cut pieces from the corresponding channels 30. Once the machining is complete, the one or more finished machined foam cores 22 may be removed from the table 70. The Turcotte sculptor 50 thus automatically machines the single raw slab 54 of the foam material 56 into the finished machined foam core(s) 22.

The Turcotte sculptor 50 is thus the high-volume 36-axis machine 52 that mass produces the machined foam core 22. The computer system 74 may individually interface with the thirty six (36) different servo-controlled linear actuators 72. The computer system 74 has a hardware processor 82 that executes a sculpting software application 84 stored in a memory device 86. The sculpting software application 84 has programming code or instructions that, when executed by the hardware processor 82, cause the hardware processor to perform operations, such as interfacing with any one or more of the thirty six (36) linear actuators 72. A first group 90 of the thirty six (36) linear actuators 72, for example, may be coupled between a frame 92 and to the table 70. The first group 90 may comprise or include a single one or multiple ones of the thirty six (36) linear actuators 72, perhaps depending on a size, shape, weight, and other design considerations. When the computer system 74 actuates any of the first group 90 of the thirty six (36) linear actuators 72, the table 70 may move, tilt, translate with respect to the frame 92, perhaps according to the sculpting software application 84. A second group 100 of the thirty six (36) linear actuators 72 may be coupled between the frame 92 and the alignment fence(s) 78. While the Turcotte sculptor 50 may have any number of moveable and/or stationary fences 78, FIG. 10 illustrates fences 78a-b. The second group 100 may comprise or include a single one or multiple ones of the thirty six (36) linear actuators 72, perhaps depending on a size, shape, weight, and other design considerations. When the computer system 74 actuates any of the second group 100 of the thirty six (36) linear actuators 72, the fence(s) 78 may raise, lower, or otherwise move into physical engagement with the raw slab 54, perhaps according to the sculpting software application 84. The fences 78 thus align the raw slab 54 to the zero/origin position 80. Still another third group 110 of the thirty six (36) linear actuators 72 may be coupled between the frame 92 and to the foam cutting system 76. The third group 110 may comprise or include a single one or multiple ones of the thirty six (36) linear actuators 72, perhaps depending on a size, shape, weight, and other design considerations. When the computer system 74 actuates any of the third group 110 of linear actuators, the foam cutting system 76 raises, lowers, or otherwise moves/translates according to a predetermined cut path 120, perhaps defined or controlled by the sculpting software application 84. By individually commanding and controlling any one or more of the thirty six (36) linear actuators 72, the computer system 74 (executing the sculpting software application 84) causes the Turcotte sculptor 50 to produce one or more machined foam core(s) 22 during a single load and machine set-up. The computer system 74, in other words, may issue commands and instructions that move or translate the table 70, and/or the foam cutting system 76, and/or the fence(s) 78 in three dimensional spatial coordinates (e.g., (x, y, z), (r, θ, Φ), or polar). Because the Turcotte sculptor 50 has the thirty six (36) linear actuators 72 (each moving/translating/stroking along a corresponding axis), the Turcotte sculptor 50 is the 36-axis machine 52.

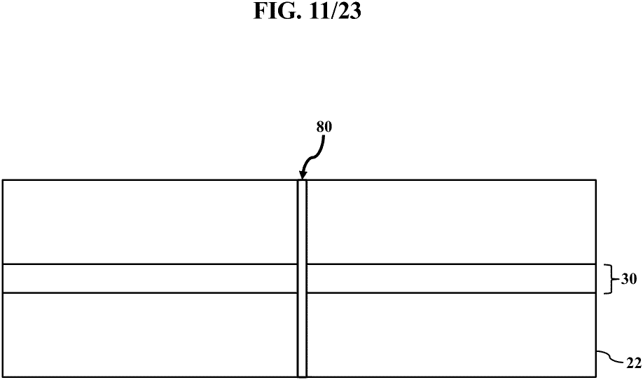

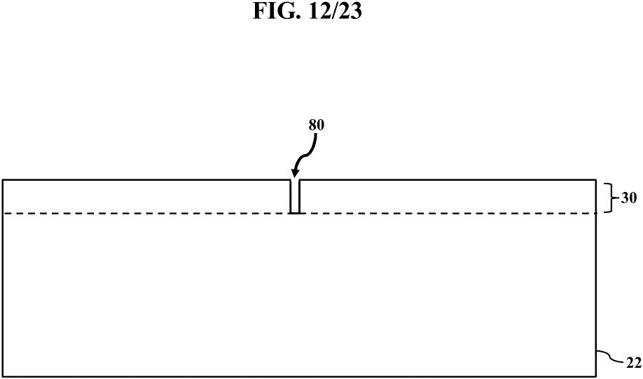

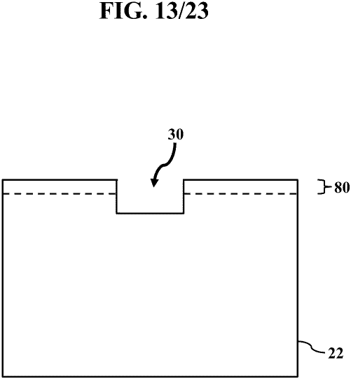

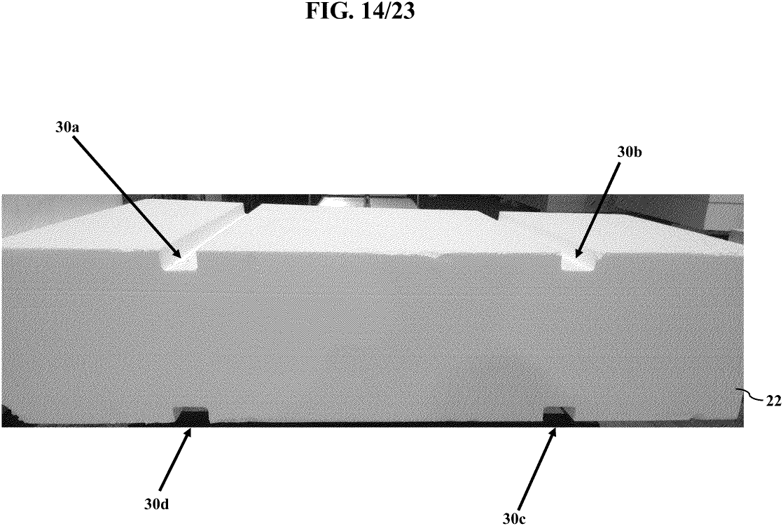

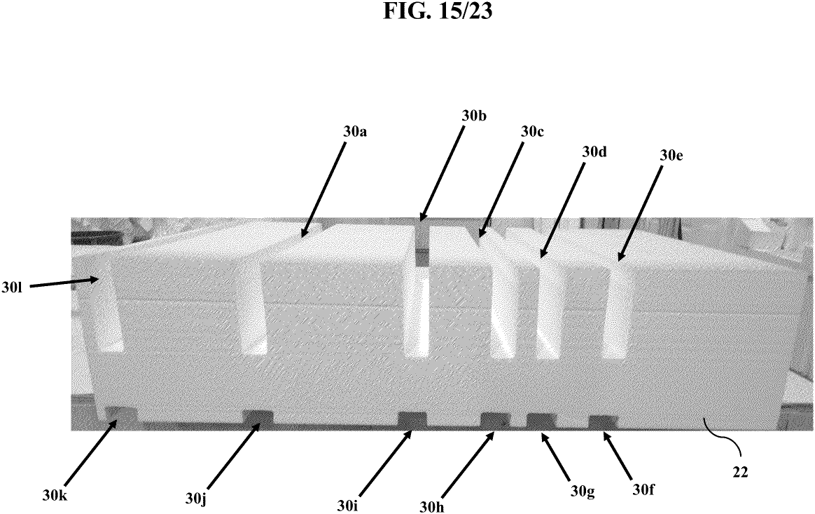

FIGS. 11-15 illustrate orthographic and isometric examples of the finished machined foam core 22. By individually commanding, actuating, and/or signaling any of the thirty six (36) linear actuators 72 (illustrated FIG. 10), the Turcotte sculptor 50 (illustrated FIG. 10) machines the raw slab 54 to create the machined foam core 22 having the channel(s) 30. The Turcotte sculptor 50 may further be programmed to cut/melt one or more chases 80. Each chase 80 is a trough, groove, channel, or conduit for electrical wire(s) and/or water pipes. The chase 80 may have a depth, width, length, and direction that suits a run of high/low voltage electrical cable or water tubing. The chase 80 may further be sized to accept outer electrical conduit.

The machined foam core 22 may have any desired sizing. Because the composite building panel 20 (illustrated in FIGS. 1-3 & 5-8) traditionally and/or commonly is rectangular, the machined foam core 22 also has the corresponding rectangular outer shape 26 and the rectangular cross section 28. The machined foam core 22 also has the material thickness 42. While the material thickness 42 may be any dimension of any value, the material thickness 42 may common conform to standard residential and commercial construction. Some residential homes are constructed using nominal 4 or 6 inch walls (e.g., 2x4 or 2x6 walls). Some residential homes and commercial/industrial buildings are constructed using 8x8x16 inch concrete slabs (or CMUs). Other sized walls and slabs are also used. The machined foam core 22 may be machined to suit any desired width, thickness/depth, and height dimension.

The composite building panel 20 is thus an environmentally friendly, insulating, and lightweight structure for use as the walls, roofs, floors and other structures in buildings. The composite building panel 20 replaces conventional insulated stud walls and concrete slabs. The composite building panel 20 is a structural element which provides both insulation properties and a shaped mass which defines the shape of the wall/roof/building to be constructed. The composite building panel 20 may use less wood, decrease construction waste, use recycled materials, and creates a building which is more energy efficient than standard construction. The composite building panel 20 is lightweight and can be molded or machined to create any desired shape. The composite building panel 20 is an insulative and structurally strong structure, while still retaining lightweight, environmentally friendly, and energy efficient characteristics.

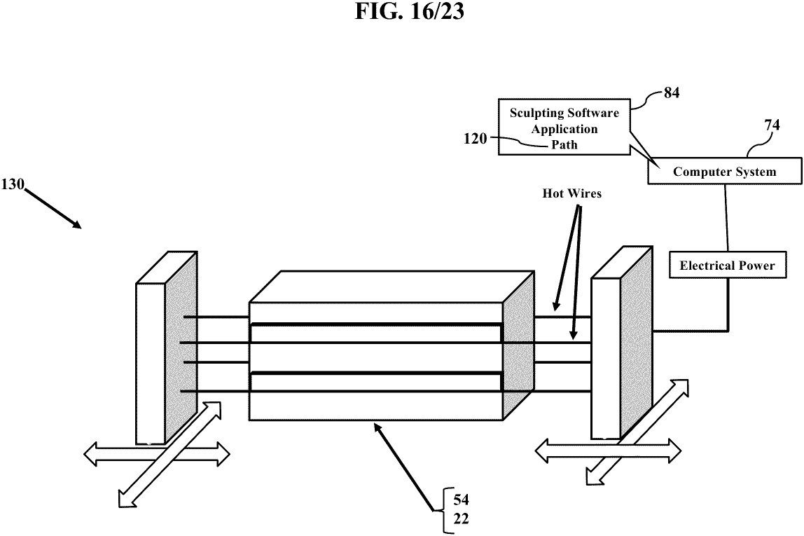

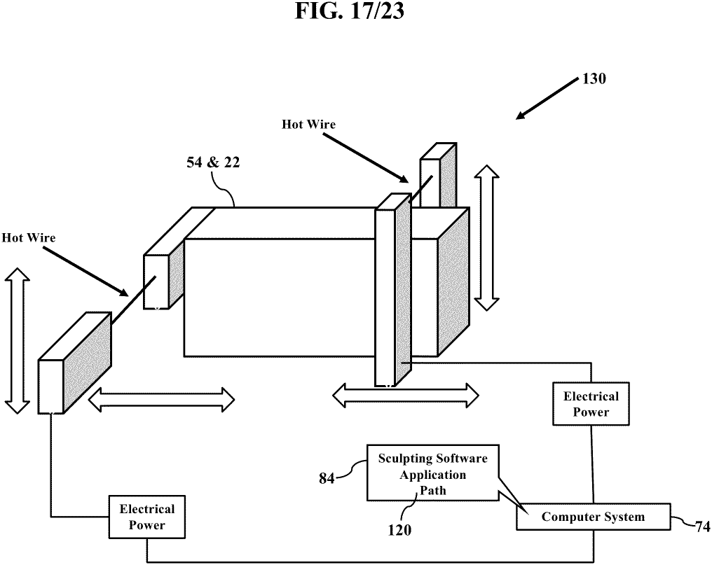

FIGS. 10 and 16-18 also illustrate examples of a hot-wire cutting system 130. The examples of the Turcotte sculptor 50 may utilize any means for cutting the single raw slab 54 of the foam material 56. The foam cutting system 76, for example, may utilize cutting/sawing blade that mechanically removes the foam material 56. The foam cutting system 76 may use any filing or broaching operation that mechanically removes the foam material 56. The foam cutting system 76 may use any milling operation that cuts/removes the foam material 56. However, the Turcotte sculptor 50 preferably uses an electrothermal hot-wire cutting system 130. The hot-wire cutting system 130 electrically heats a thin wire that melts the foam material 56. The computer system 74, in other words, instructs or causes the hot-wire cutting system 130 to apply electrical power (e.g., AC/DC voltage and current) to a wire. The wire may be thick or thin, depending on a desired cut slot width. The electrical power causes resistive heat to outwardly conduct from the thin wire. By commanding and controlling the third group 110 of the thirty six (36) linear actuators 72 (coupled to the hot-wire cutting system 130), the computer system 74 is able to move the hot wire and trace the predetermined path 120 according to the sculpting software application 84.

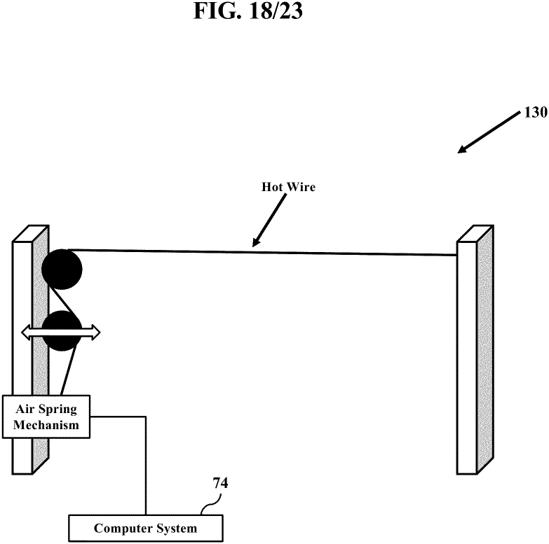

The hot-wire cutting system 130 produces a clean cut. Mechanical cutting/sawing generates much foam residue. Moreover, the mechanical cutting also generates heat that melts the foam EPS material 56. In short time, then, a cutting blade gums and clogs, thus greatly reducing cutting effectiveness. The hot-wire cutting system 130, instead, melts the foam EPS material 56 without physical contact. The hot wire, in other words, need not contact the foam EPS material 56. The hot wire cutting system 130 may thus melt hundreds or even thousands of linear feet of the foam material 56 without service or replacement. The sculpting software application 84 may thus include programming code that maps, relates, or associates different electrical powers (e.g., current/voltage) to different wire temperatures and to different linear speeds. The electrical power applied to the wire, in other words, may determine the linear speed at which the hot wire may be moved. The sculpting software application 84 may thus balance electrical power usage with melting speed to ensure the hot wire does not touch the foam material 56. If the hot wire moves too fast, the thin hot wire will contact the foam material 56 and locally deform a cut slot or path 120. FIG. 18 illustrates a hot-wire tensioning system for maintaining the tension in the hot wire. The Turcotte sculptor 50 uses pulley-air spring mechanisms to create a tension on each Hot Wire. Each wire is secured or anchored at one end. An opposite end is attached or secured to the air-spring mechanism. The wire wraps or routes over/along a top/first fixed pulley and over/along a bottom/second pulley. The bottom/second pulley travels along an axis and is adjustable by the air-spring mechanism. An air pressure within the air-spring mechanism determines a travel or position of the bottom/second pulley. The tension is controlled by a closed loop electrically controlled air pressure regulator. The air pressure may be controlled by an air pressure switch, a solenoid, or any other means for mechanical/pneumatic control. The computer system 74 may also interface with the air-spring mechanism (via the communications network) and programmably control the tension on the hot wire by commanding the air-spring mechanism to increase/decrease the internal air pressure. The examples may use other spring systems to maintain a tension in the hot wire.

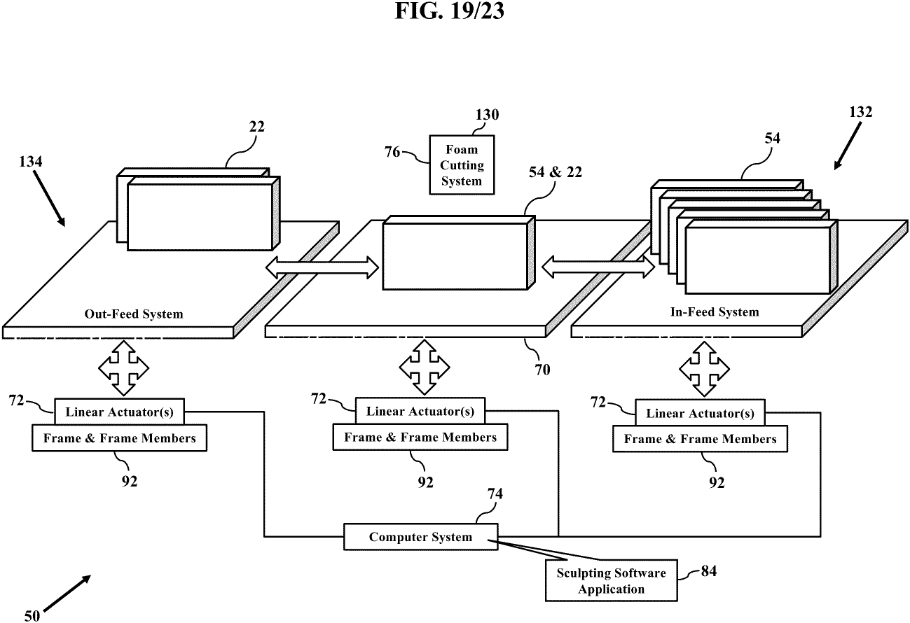

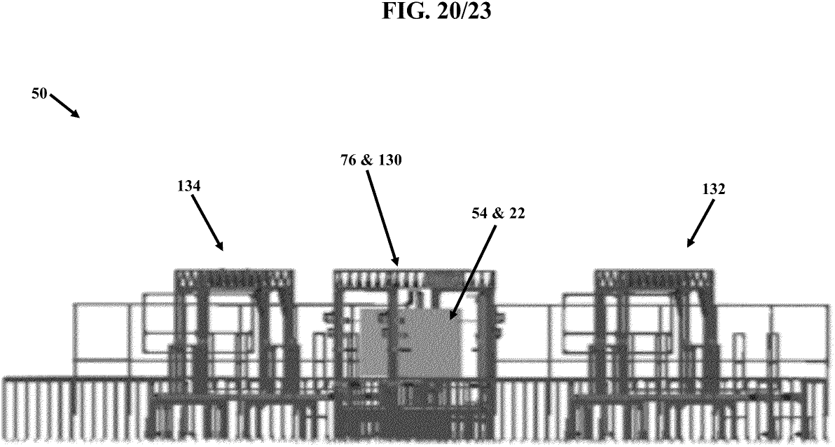

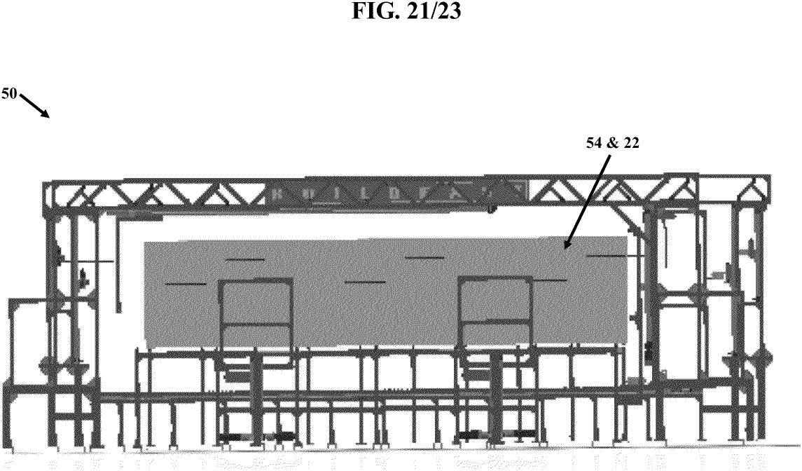

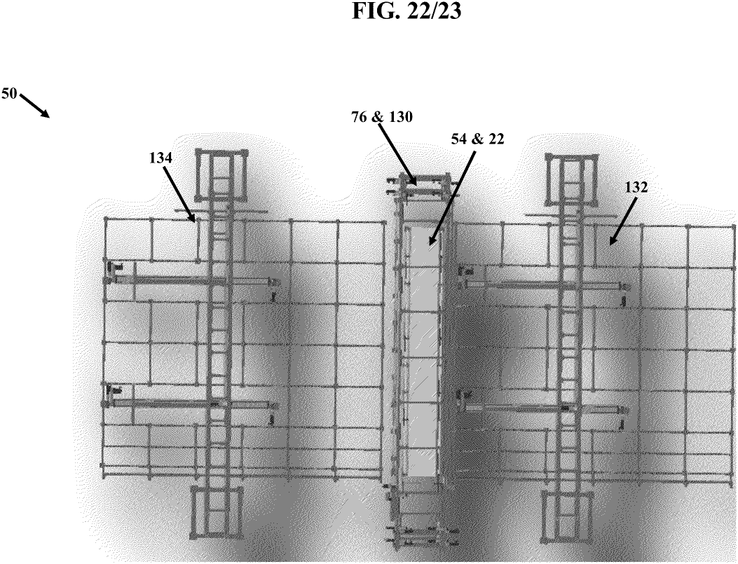

FIGS. 19-22 illustrate more examples for volume production. The Turcotte sculptor 50 may include an in-feed system 132 that stores or holds multiple raw slabs 54 for staged sculpting. FIG. 19, for example, illustrates five (5) raw slabs 54 loaded into the in-feed system 132, but the examples may contain more or less. A forklift driver, for example, may easily load the in-feed system 132 with as many raw slabs 54 as a tray or rack capacity permits. The in-feed system 132, when activated, automatically feeds one or more of the raw slabs 54 onto the table 70 for machining into the machined foam core(s) 22. The in-feed system 132 may include any number of the linear actuators 72 that horizontally/vertically move, push, lift, lower, enter, shuttle, and/or slide a virgin slab 54 onto the table 70. Then, as the foam cutting system 76/130 operates, the in-feed system 132 may reset, acquire, and prepare to insert another raw slab 54. The in-feed system 132 may thus sequentially queue and load raw slabs 54 as fast as the foam cutting system 76/130 can produce machined foam cores 22.

The Turcotte sculptor 50 may include an out-feed system 134. The out-feed system 134 stores or holds finished machined foam core(s) 22. That is, once the foam cutting system 76/130 has completed cutting the machined foam core 22, the out-feed system 134 may be activated to automatically acquire and remove the machined foam core 22 from the table 70. The in-feed system 132 may include any number of the linear actuators 72 that horizontally/vertically move, lift, lower, push, exit, shuttle, and/or slide the machined foam core 22 off the table 70. Then, as the foam cutting system 76/130 operates, the out-feed system 134 may reset, acquire, and prepare to eject another machined foam core 22 from the table 70. The out-feed system 134 may thus sequentially queue and store machined foam cores 22 as fast as the foam cutting system 76/130 can operate. Moreover, the out-feed system 134 may arrange and stage the multiple machined foam cores 22. The out-feed system 134 may thus have a tray or rack capacity for storing multiple machined foam cores 22. A forklift driver need only drive up, lift, and remove the multiple machined foam cores 22 from the out-feed system 134.

The Turcotte sculptor 50 provides volume production. The computer system 74 interfaces (via the communications network) with the linear actuators 72, the foam cutting system 76/130, the in-feed system 132, and the out-feed system 134. The sculpting software application 84 instructs or causes the computer system 74 to coordinate the linear actuators 72 to shuttle-shift raw slabs 54 into the in-feed system 132 and to shuttle-shift the machine foam core 22 from the out-feed system 134. At generally the same time, the computer system 74 is also coordinating the linear actuators 72 and the foam cutting system 76/130 to produce another machined foam core 22 that is currently loaded on the table 70. The Turcotte sculptor 50 is thus a volume production machine that creates the machined foam cores 22 at volume quantities. The overall cycle time is thus generally governed by the electrical power provided to the foam cutting system 76/130 (e.g., the linear cut speed along the path 120) and the amount/complexity of the channels 30, chases 80, and other cutouts. As a further enhancement, the Turcotte sculptor 50 may include a printing mechanism that prints, labels, or marks each machined foam core 22 with a unique identifier. The unique identifier may be a manufacturing serial number. The unique identifier may additionally or alternatively specify a wall number and/or an installation or sequence number that aids installers. The unique identifier, though, may additionally or alternatively specify a purchase order, a builder/contractor, an architect, a lot number, and any other helpful identification information.

The machined foam core 22 is a single-height wall section. Even though the machined foam core 22 may have any size, the machined foam core 22 is preferably cut from the single raw slab 54 of foam material 56. The single raw slab 54 of foam material 56 preferably has generally the same height and thickness as the residential/commercial wall specified by the construction drawings. The single raw slab 54 of foam material 56, in other words, may be received from a supplier and need only be nominally cut in height and thickness to match the construction drawings. As an example, suppose the single raw slab 54 of foam material 56 is nominally 4 feet wide, 9 feet in length, and 6 inches in the material thickness 42. The single raw slab 54 of foam material 56, in other words, may nominally match a typical 2x6 construction for 9 feet walls. The single raw slab 54 of foam material 56 may thus be loaded into the Turcotte sculptor 50 and automatically machined to create the machined foam core 22. That is, the Turcotte sculptor 50 may trim the single raw slab 54 to a finished length, width, and/or thickness dimension. Moreover, the Turcotte sculptor 50 may also automatically machine the channel(s) 30 and/or the water/electrical chase(s) 80, if required by construction drawings. Because the machined foam core 22 is a single-height wall section, the machined foam core 22 is far larger than smaller foam bricks. Many wall panels are constructed of small bricks or slabs that are stacked to create a larger wall section. The machined foam core 22, in contradistinction, is a single piece, single-height wall section that installs far faster using much less labor. Moreover, because the machined foam core 22 is a single piece, single-height floor-to-ceiling wall section, stops airflow (“airtight”) between bricks/slabs without air sealing additives (such as foam sealant). The machined foam core 22 thus greatly reduces exterior-to-interior air exchanges. The machined foam core 22 also eliminates thermal breaks at conventional wood/steel studs.

The Turcotte sculptor 50 machines any sized raw slab 54 of foam material 56. The table 70 is large enough to accept multiple large slabs 54 staged for sequential machining (such as the raw foam slabs 54 measuring at least 18 feet in length, 4 feet in width, and 2 feet in the material thickness 42). The table 70, of course, may be enlarged to machine even larger slabs. Currently, though, 18x4x2 feet slabs are the largest available, to the inventor’s knowledge. Once the raw slab 54 is loaded onto the table 70 (perhaps by hand placement, forklift, or crane), the operator need only then select inputs to the Turcotte sculptor 50. The operator, for example, may select a cut file that is associated with, or that defines, the cut path 120 to be traced within the raw slab 54. The Turcotte sculptor 50 thus automatically begins trimming, shaping, and/or cutting the raw slab 54 to create one or more of the machined foam cores 22 from the same or common single raw slab 54. The Turcotte sculptor 50 may further cut/melt and remove the channels 30 and/or the chases 80. The Turcotte sculptor 50 may further cut/melt and remove the foam material 56 for windows and doors. The Turcotte sculptor 50 may thus automatically perform all these melting/cutting operations in a single set-up of the raw slab 54 onto the table 70. Indeed, because the Turcotte sculptor 50 may machine such a large 18x4x2 feet raw slab 54, multiple machined foam cores 22 may be nearly simultaneously produced from the single large 18x4x2 feet raw slab 54. A large slab 54, in other words, contains enough foam material 56 to machine multiple machined foam cores 22. The Turcotte sculptor 50 has the infeed and outfeed table 70 to feed and exit multiple machined foam cores 22 at one time. The machined foam cores 22 can be random sizes in the queue once the operator inputs the data and the Turcotte sculptor 50 will adapt to the new raw slab 54. This unique capability allows for higher production rates for a single machine.

The frame 92 may be constructed of any material. Because the Turcotte sculptor 50 has such a large capacity (e.g., a 18x4x2 feet raw slab 54), the frame 92 is preferable constructed using extruded aluminum framing members. Extruded aluminum has a high strength and a relatively low weight. Extruded aluminum is also inexpensive and easily adaptable (e.g., cutting and TIG welding) to future changes. This reusable and extendable machine structure also means the frame 92 can be broken down into smaller shippable sections for reassembly. The Turcotte sculptor 50 may thus be easily shipped for local production near construction sites (and thus reducing transportation costs for the finished products). The frame 92, however, may be constructed of any grade or composition of steel, polymer/plastic, wood, or fiber/carbon/glass/composite material.

The Turcotte sculptor 50 may use any actuator mechanism or components. The thirty six (36) linear actuators 72, for example, are preferable highly-precise, servo-controlled Linear Module Technology which provides precise rigid movements for repeatable high tolerance walls and roofs. These actuator modules are programmable, thus allowing for a wide variety of finished walls and ceilings. While the computer system 74 that controls the Turcotte sculptor 50 may have any design, the computer system 74 may include the World Class PLC machine control system which can control up to 64 independent axis, 32 controller axis, 16 Kinematics, at 250 uses position loop updates. The PLC is a multi-tasking multi-processing controller capable of controlling additional future axis without needing a new control. It includes an OPCUA Server feature for connecting to other 3rd Party products such a future SCADA. It also includes electronic gearing for synchronizing axes together, so the cuts are parallel and square for high tolerance walls and ceilings. The Turcotte sculptor 50 thus ensures good cuts even on the longest of cuts. This reduces scrap and increases efficiency. The Turcotte sculptor 50 may further include a 21-inch or larger/smaller LED/LED display device and multi-finger touch Human Machine Interface (HMI). This allows a machine owner/operator to develop recipes so popular walls and ceilings can be repeated by a single part number.

The Turcotte sculptor 50 may use servo drives which allows the drives to be mounted directly unto the frame 92 close to the servo motors, thus reducing the size of a machine electrical panel and making the breakdown and moving of the Turcotte sculptor 50 to new location easier than servos that require to be mounted in an electrical panel. Included in the servo drives are their world leading S3 Safe Motion where IEC safety is included inside each servo drive. This feature allows the machine owner/operator to keep the main AC power on while entering a “Safe State” and then allow the operator to clear a jam or a cut out that is stuck, by using S3 features such as Safe Limited Speed and Safe Limited Direction, then resuming production without having to wait for power up sequencing. It is a real productivity improver. A central power bus architecture also reduces cabling.

The Turcotte sculptor 50 may use World Class servo motors directly mounted to the linear modules for a rigid compact design. These motors include multi-turn high resolution feedback for absolute positioning. No need to home each axis every time you turn the machine power on. This is a great productivity improvement for the machine. These motors include where required an electrically held open and spring closed Holding Brake. The servo motors and drive and machine control include hundreds of diagnostics to help reduce time should something happen. The drives monitor the health of the drives, the motors, the feedbacks, the wiring and the input voltages and will provide a diagnostic message indicating what needs to be addressed.

Now explained are examples of sequencing operations for machining the raw slab 54 to produce the machined foam core 22. The raw slab 54 is loaded onto the table 70 by an in-feed system (illustrated in FIGS. 19-22). At least one of the linear actuators 72 (axis #1) may push or move the raw slab 54 to a wall, barrier, or other fence 78. Axis 2,3,4,5 raise a moving wall or fence 78 from beneath the load table 70. Axis 6 & 7 (extends) shifts the slab 54 into a center position. Axis 2,3,4,5 lower the moving wall/fence 78 below a loading deck. Axis 6 & 7, (retracts) the moving wall 78 so they can load another subsequent slab 54. Axis 8 & 9 of the unload table 70 extends underneath the slab 54 and far enough to raise another moving wall 70 and “Pull” slab 54 into the center. Axis 10,11,12,13 of the unload table 70 raises the wall 78. Axis 8 & 9 then moves the slab 54 into the center. Axis 8 & 9 will wait until the slab 54 is processed. Axis 10,11,12, 13 lower to get their moving wall 78 out of the way, then suction cups are turned on and hold the slab 54 down in the center. Axis (14, 15 Lt/RT of inside upper) (16,17 Lt/Rt of inside lower) (18,19 Lt/Rt of outside upper) (20,21 of Lt/Rt of outside lower) ALL raise or lower to the starting positions for channels 30. Axis (22, 23 Lt/Rt of inside upper) (24,25 Lt/Rt of inside lower) (26,27 Lt/Rt of outside upper) (28,29 of Lt/Rt of outside lower) ALL extend into the slab 54. Axis (14, 15 Lt/RT of inside upper) (16,17 Lt/Rt of inside lower) (18,19 Lt/Rt of outside upper) (20,21 of Lt/Rt of outside lower) ALL lower to carve channels 30 and/or chases 80. Axis (22, 23 Lt/Rt of inside upper) (24,25 Lt/Rt of inside lower) (26,27 Lt/Rt of outside upper) (28,29 of Lt/Rt of outside lower) ALL retract to carve the slab 54. All axis 14-29 go to the starting positions away from the slab 54 which is out of the way for the window/door or electrical carvings. The window/door hot wire starts cutting from the top side of the slab 54. Axis 30 and 31, move to the left to position the window/door hot wire. This move is sync’d. These axis are the rack and opinions. Axis 32 and 33, move down sync’d. Axis 31 and 31, move either left or right sync’d. Axis 32 and 33, move up sync’d. Axis 30 and 31 move left or right sync’d. Axis 32 and 33, move up out of the slab 54. Note: Can cut a door and a window in one slab - following steps 18-23 again. Next Cut out a vertical trough for either electrical conduit or water line. All other functions must be back in their home positions. Axis 30 & 31 move to their starting positions. Axis 35 & 36, extend into the foam to depth. Axis 30 & 31 move to their target position in the foam. Axis 35 &36 move to exit the foam cutting out the trough. Axis 30 & 31, 35 & 36 move to the home positions. Assuming the moving wall of the unloading table is not in the correct position. Axis 10,11,12,13 of the unload table 70 lowers the moving wall 78 of the unload table 70 - beneath the unload table 70. Axis 8 & 9 of the unload table 70 extends the unload wall 78 underneath the slab 54 and far enough to raise another moving unload wall 78. Axis 10,11,12,13 of the unload table 70 raises the wall 78. Axis 8 & 9 then pulls the slab 54 away from the center of the machine unto the unload table 70. Axis 8 & 9, lowers the unloading moving wall 78 underneath the unload table 70. Axis 34 is another moving wall 78 on the unload table 70 that shifts the finished foam slab 54 to the left against a fixed rigid wall 78. Axis 34 shifts to the right position if it is not already there. Axis 34 shifts the finished slab 54 left against a rigid wall. Axis 34 shifts back right. All positions and velocities will be given by recipes/paths 120 selected by operator using MMI to computer system 74. The computer system 74 commands either a PWM or On/Off signal to each hot wire to create heat in the wire. There are four wires for the stud channel 30. One wire for the window/doors and one more wire for the electrical/water chase 80. Total 6 hot wires. Will provide the math for cyclically turning On/Off the 24 VDC current to hot wires. On/Off signals will control a 24VDC/220VDC SS PWM Relay. The Turcotte sculptor 50 uses pulley-air spring mechanisms to create a tension on each Hot Wire. The examples may use other spring systems to maintain a tension in the hot wire. The tension is controlled by a closed loop electrically controlled air pressure regulator. There are times when 4 axis need to be sync’d to push or pull the foam slabs into or out of the machine. There are times for carving out the studs cavities, the (up and down) an (in and out) axis need to be sync’d. There are times when carving out the windows/doors, the (left and right) axis and the (up and down) axis need to be sync’d. There are times when carving out the electrical conduit, the (left and right) and the (in and out) axis need to be sync’d. Finally, there will be 6 PI controls to control the current to the hot wires which create temperature so the hot wires can cut the foam.

Still more examples of sequencing operations are provided. Once the new slab is loaded and shifted to the left side, then axis 2, 3, 4, & 5 raise underneath the loading table and lifts up the slab(s) off the loading table. All four axis need to be electronically geared together so it lifts the slab(s) uniformly. Once the slab(s) are raised to the target height, then axis 6 & 7 shifts the moving wall towards the center of the machine for processing. Axis 6 & 7, retract to starting position. Axis 2, 3, 4 & 5, retract downward below the loading deck. Axis 10, 11, 12, &13 are electronically geared which comes from the unload table extends underneath the slab and far enough to raise another moving wall (axis 8 & 9) and “Pulls” slab into the center of the machine. Axis 8 & 9 are electronically geared. Axis 8 & 9 raise up once axis 10, 11,12, &13 are extended in the correct position. Axis 10,11,12,13 of the unload table raises the wall. Axis 8 & 9 then moves the slab into the center of the machine. Once one of the slabs is loaded unto the center of the machine. Suction cups are enables securing the slab in place during processing. Axis 8 & 9 retracts to starting position underneath the table once the suction cups are enabled. Axis 10, 11, 12 & 13, retract downward below the loading deck after axis 8 & 9 are retracted below the table and the suction cups are enabled. Note all axis # 14 to 36 must be in fully retracted positions before this step starts out of the way of the slab as it moves in. Electrical power (AC/DC voltage and current) is sent, pulsed, and/or applied to the hot knifes prior to cutting/melting, and when they should start pulsing the current before starting to cut the foam. Axis 14, 16, 18, 20, 22, 24, 26 & 28 are vertical. Axis 14, 16, 22 & 24 are retracted below the incoming slab as their starting positions. Axis 18, 20, 26 & 28 are retracted above the incoming slab as their starting positions. Axis 15, 17, 19, 21, 23, 25, 27, 29 are horizontal and are retracted for the starting positions. Once the slab is in place and secure (lock with suction sensor), then Axis 14, 16, 18, 20, 22, 24, 26 & 28 move to their initial starting positions for cutting. The following axis are electronically geared together: Axis 14& 16, Axis 18 & 20, Axis 22 & 24, Axis 26 & 28. Once the above axis are in position, then Axis 15, 17, 19, 21, 23, 25, 27, 29 start moving into the foam to their target positions. The following axis are electronically geared together: Axis 15 & 17, Axis 19 & 21, Axis 23 & 25, Axis 27 & 29. Once the above axis are in position, then Axis 14, 16, 18, 20, 22, 24, 26 & 28 start moving to their next target positions, electronically geared together. Once the above axis are in position, then Axis 15, 17, 19, 21, 23, 25, 27, 29 start moving to their next target positions, electronically geared together. At this point the shape of a stud may fall out or is removed by a human or a vacuum or something. Once the cut out is removed then all axis move to their starting and retracted positions. 4-pairs of horizontal hot wires move up and down, then when in position vertically, move into the foam. Then move down or up in the foam, then move out of the foam. When the cut out is removed, then an alignment member 24 may be inserted by hand and horizontal wall is turned up right. Accuracy requested is no less than ⅛th of an inch. No interpolated motion is requested. So there are four pair of coordinated axis here.

Cutouts for windows and doors may be performed. Axis 30 & 32 are horizontal and electronically geared together to move as one. Axis 31 & 33 are vertical and electronically geared together to move as one. Axis 30, 31, 32, 33 start fulling retracted above and the right of the foam slab so they don’t interfere with stud hot knifes. Axis 30 & 32 move their initial target positions. When axis 30 and 32 are in position, then axis 31 & 33 move down to their initial target positions. When axis 31 and 33 are in position, then axis 30 & 32 move down to their next target positions. The two above steps keep repeating to new target positions until the door or wind cut out is complete. Once the cut out is complete, then the cut out may fall out, be extract by suction or by actuator movement, or by a human effort. Once the cut out is removed then all axis move to their starting and retracted positions. The hot wire travels above the foam slab 54 until it reaches the position to begin insertion/movement into the foam slab 54 along the path 120. The left right motion is driven by two rack and pinions - and the up/down by two linear actuators. There is one pair sync’d axis horizontally and one pair sync’d vertically.

Cutouts for the water/electrical chases 80 may be performed. All of the electrical axis may be fully retracted and out of the way before this step begins. The electrical conduit cut out shares the moving structure of the Window/Door mechanism. So Axis 30 & 32 are horizontal and electronically geared together to move as one. Axis 35 & 36 are horizontal and are not always electronically geared together to move as one. Axis 30 & 32 move their initial target positions. When axis 30 and 32 are in position, then axis 35 or 36 move in to their initial target positions. When axis 35 or 36 are in position, then axis 30 & 32 move to their next target positions. The two above steps keep repeating to new target positions until the door or wind cut out is complete. The two above steps keep repeating to new target positions until the door or wind cut out is complete. Once the cut out is removed then all axis move to their starting and retracted positions. Electrical conduit or water line cut out. There are two new additional linear modules on this one front side window/door frame (not on the back window/door frame), which moves in and out into the foam to carve out a trough for electrical conduit or water line. The back frame has to move too because of the window/door wire. Then there are two linear modules on the front frame. The back frame has to move too because of the window/door wire. Then there are two linear modules on the front frame that move sync’d together in and out into the foam to carve out a vertical trough.

Cut scrap may be removed. Once the channel(s) 30 and/or the chase(s) 80 are cut, their resulting scrap pieces may be removed. All of the electrical axis must to fully retracted and out of the way before this step begins. Axis 10, 11, 12, &13 are electronically geared which comes from the unload table extends underneath the slab and far enough to raise another moving wall (axis 8 & 9) and “Pulls” slab away from the center of the machine. Axis 8 & 9 are electronically geared. Axis 8 & 9 raise up once axis 10, 11,12, &13 are extended in the correct position. Axis 10,11,12,13 of the unload table raises the wall. Axis 8 & 9 then moves the slab into the edge of the unloading table. Axis 8 & 9 retracts to starting position underneath the unload table once the target position is reached. Axis 10, 11, 12 & 13, retract downward below the loading deck after axis 8 & 9 are retracted below the table. Note all axis # 14 to 36 must be in fully retracted positions before this step starts out of the way of the slab as it moves in. Unload station. Two lift and carry mechanisms shift the slabs to the center of the machine where hot wires carve out shapes. So there are four sync’d axis to raise and lower. Then there are two axis that shift the slab to the center of the machine. The finished machined foam core(s) 22 may be unloaded from the table 70 (by human effort, by forklift, or by crane/machine). The Turcotte sculptor 50 is ready for another setup to machine another raw slab 54.

Yet more examples of sequencing operations are provided.

1) Fork truck loads a slab unto the load table.

Next is the sequence from handling the foam slab and putting into the center of the machine for processing.

2) Axis 1 shifts the slabs from right to left against a fixed and rigid wall.

3) Axis 2,3,4,5 raise the moving wall from beneath the load table - sync’d.

4) Axis 6 & 7 (extends) shifts the slab into the center of the machine

5) Axis 2,3,4,5 lower the moving wall below the loading deck.

6) Axis 6 & 7, (retracts) the moving wall so they can load another slab.

7) Axis 8 & 9 of the unload table extends underneath the slab and far enough to raise another moving wall and “Pull” slab into the center of the machine.

8) Axis 10,11,12,13 of the unload table raises the wall.

9) Axis 8 & 9 then moves the slab into the center of the machine.

10) Axis 8 & 9 will wait until the slab is processed.

Next are the moves for the studs. Note they may only carve out ONE stud per side or they may carve out two studs per side.

11) Axis 10,11,12, 13 lower to get their moving wall out of the way, then suction cups are turned on and hold the slab down in the center of the machine.

12) Axis (14, 15 Lt/RT of inside upper) (16,17 Lt/Rt of inside lower) (18,19 Lt/Rt of outside upper) (20,21 of Lt/Rt of outside lower) ALL raise or lower to the starting positions for studs.

13) Axis (22, 23 Lt/Rt of inside upper) (24,25 Lt/Rt of inside lower) (26,27 Lt/Rt of outside upper) (28,29 of Lt/Rt of outside lower) ALL extend into the foam slab.

14) Axis (14, 15 Lt/RT of inside upper) (16,17 Lt/Rt of inside lower) (18,19 Lt/Rt of outside upper) (20,21 of Lt/Rt of outside lower) ALL lower to carve studs.

15) Axis (22, 23 Lt/Rt of inside upper) (24,25 Lt/Rt of inside lower) (26,27 Lt/Rt of outside upper) (28,29 of Lt/Rt of outside lower) ALL retract to carve the foam slab.

16) All axis 14-29 go to the starting positions away from the foam slab which is out of the way for the window/door or electrical carvings.

The window/door hot wire starts cutting from the top side of the foam slab.”

17) Axis 30 and 31, move to the left to position the window/door hot wire. This move is sync’d. These axis are the rack and opinion’s.

18) Axis 32 and 33, move down sync’d.

19) Axis 31 and 31, move either left or right sync’d.

20) Axis 32 and 33, move up sync’d.

21) Axis 30 and 31 move left or right sync’d.

22) Axis 32 and 33, move up out of the slab.

Note they may carve a door and a window in one slab — following steps 18-23 again. “

Next is carving out a vertical trough for either electrical conduit or water line. All other functions must be back in their home positions.

23) Axis 30 & 31 move to their starting positions.

24) Axis 35 & 36, extend into the foam to depth

25) Axis 30 & 31 move to their target position in the foam

26) Axis 35 &36 move to exit the foam cutting out the trough.

27) Axis 30 & 31, 35 & 36 move to the home positions.

“Assuming the moving wall of the unloading table is not in the correct position.”

28) Axis 10,11,12,13 of the unload table lowers the moving wall of the unload table — beneath the unload table.

29) Axis 8 & 9 of the unload table extends the unload wall underneath the slab and far enough to raise another moving unload wall..

30) Axis 10,11,12,13 of the unload table raises the wall.

31) Axis 8 & 9 then pulls the slab away from the center of the machine unto the unload table of the machine.

32) Axis 8 & 9, lowers the unloading moving wall underneath the unload table.

33) “Axis 34 is another moving wall on the unload table that shifts the finished foam slabs to the left against a fixed rigid wall.”

34) Axis 34 shifts to the right position if it is not already there.

35) Axis 34 shifts the finished slabs left against a rigid wall.

36) Axis 34 shifts back right.

“All positions and velocities will be given by recipes from our HMI.”

37) “Our XM will also be providing either a PWM or On/Off signal to each hot wire to create heat in the wire. There are four wires for the stud. One wire for the window/doors and one more wire for the electrical. Total 6 hot wires. Electrical power may cyclically turn On/Off the 24 VDC current to hot wires. Our On/Off signals will control a solid-state transistor relay.

38) Air may be used to create a tension on each Hot Wire. The tension is controlled via electrically-controlled air pressure regulator. Air pressure springs are an elegant and simple tension control scheme. The tension, though, may be controlled by any electronic/mechanical means.
· There are 36 axis per machine.
· There are times when 4 axis need to be sync’d to push or pull the foam slabs into or out of the machine.
· There are times for carving out the studs cavities, the (up and down) an (in and out) axis need to be sync’d. There could be two studs on each side of the foam slab.
· There are times when carving out the windows/doors, the (left and right) axis and the (up and down) axis need to be sync’d.
· There are times when carving out the electrical conduit, the (left and right) and the (in and out) axis need to be sync’d.
· Finally, there will be 6 PI controls to control the current to the hot wires which create temperature so the hot wires can cut the foam.

The computer system 74 may access a Turcotte database. The Turcotte database may be locally stored in the memory device 86 (illustrated in FIG. 10). The Turcotte database, however, may be remotely stored and accessed via the communication network from any networked device or location. The Turcotte database has entries that map, relate, or associate the temperature of the hot wire to the electrical power applied to the hot wire. Moreover, the Turcotte database may also have entries that map, relate, or associate the material thickness 42 of the raw slab 54 to the temperature of the hot wire and to a linear speed at which the hot wire may trace the path 120 defined according to the sculpting software application 84. The material thickness 42 and the linear speed may thus determine the electrical power applied to the hot wire. Conversely, the material thickness 42 and the electrical power may optionally determine the linear speed at which the hot wire may travel within the raw slab 54. The computer system 74 may thus query the Turcotte database for a query parameter (such as a desired linear speed) to identify the corresponding entry for the electrical power. By varying the electrical power, the sculpting software application 84 may vary the cut/melt speed. A human operator may also have permissions to vary the electrical power to increase/decrease the cut/melt speed. Furthermore, the Turcotte database may also have entries that map, relate, or associate the electrical power to a tension or sag within the hot wire. As the temperature increases, the hot wire will likely sag (e.g., tension decreases) and reduce a dimensional accuracy of the cut. The Turcotte database may thus entries that define different tension values and wire temperatures. The computer system 74 may thus query for linear speed and identify the corresponding electrical power and tension value. The computer system 74 may then command a tensioner system to apply or produce the tension value (such as air spring psi) in the hot wire.

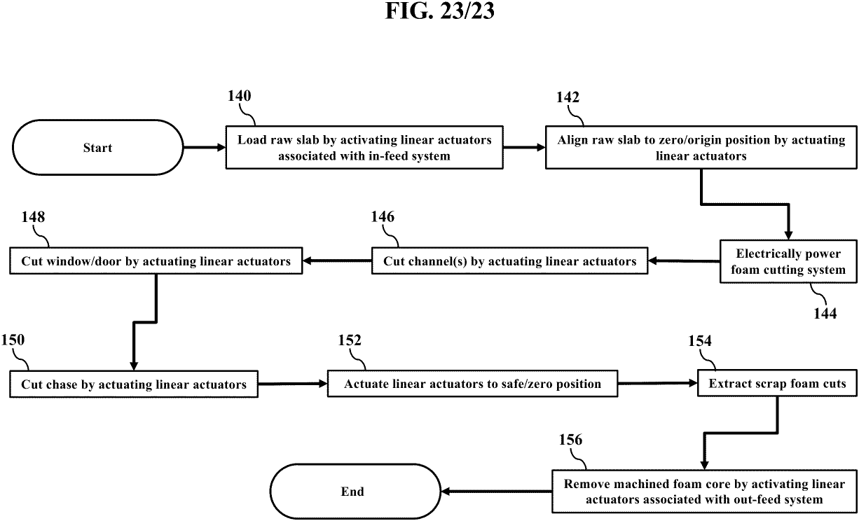

FIG. 23 illustrates examples of a method or flow chart for machining the raw slab 54 using the Turcotte sculptor 50. The virgin raw slab 54 is loaded by the in-feed system 132 (Slab 140). The raw slab 54 is aligned to the zero/origin position (Slab 142). Electrical power is provided to the foam cutting system 76 (such as the hot-wire cutting system 130) (Slab 144). One or more of the channels 30 are cut by the foam cutting system 76 (Slab 146). Cutouts for windows and/or doors are performed (Slab 148). One or more of the chases 80 are cut by the foam cutting system 76 (Slab 150). The linear actuators 72 are activated (extended or retracted) to a safe or zero position (Slab 152) and scrap cuts are extracted (Slab 154). The scrap cuts may fall by gravity orientation, or the scrap cuts may be machined-removed by activating some of the linear actuators and/or by pneumatic suction. However, if human, manual extraction is used, the safe/zero position moves the table 70, the fence(s) 78, the foam cutting system 76, the in-feed system 132, and/or the out-feed system 134 to a predefined neutral or other location. A human operator may then manually reach in and remove any scrap cuts. However the scrap cuts are removed, the out-feed system 134 is actuated to remove the machined foam core 22 (Slab 156).

The computer system 74 may have any embodiment. The sculpting software application 84 is stored in the memory subsystem or device 86. One or more of the processors 82 communicate with the memory subsystem or device 86 and execute the sculpting software application 84. Examples of the memory subsystem or device 86 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology. The computer system 74, however, may have any embodiment, such as a PLC controller, computer server, switch, router, or any other network member of a cloud computing environment. The computer system 74 may also be a smartphone, a tablet computer, or a smartwatch. The computer system 74 may also be easily adapted to other embodiments of smart devices, such as a television, an audio device, a remote control, and a recorder. The computer system 74 may also be easily adapted to still more smart appliances, such as washers, dryers, and refrigerators. Indeed, as cars, trucks, and other vehicles grow in electronic usage and in processing power, the computer system 74 may be easily incorporated into any vehicular controller.

The above examples may be applied regardless of the networking environment. The sculpting software application 84 may be easily adapted to stationary or mobile devices having wide-area networking (e.g., 4G/LTE/5G cellular), wireless local area networking (WI-FI°), near field, and/or BLUETOOTH^{®} capability. The sculpting software application 84 may be applied to stationary or mobile devices utilizing any portion of the electromagnetic spectrum and any signaling standard (such as the IEEE 802 family of standards, GSM/CDMA/TDMA or any cellular standard, and/or the ISM band). The sculpting software application 84, however, may be applied to any processor-controlled device operating in the radio-frequency domain and/or the Internet Protocol (IP) domain. The sculpting software application 84 may be applied to any processor-controlled device utilizing a distributed computing network, such as the Internet (sometimes alternatively known as the “World Wide Web”), an intranet, a local-area network (LAN), and/or a wide-area network (WAN). The sculpting software application 84 may be applied to any processor-controlled device utilizing power line technologies, in which signals are communicated via electrical wiring. Indeed, the many examples may be applied regardless of physical componentry, physical configuration, or communications standard(s).

The computer system 74 may utilize any processing component, configuration, or system. For example, the computer system 74 may be easily adapted to any desktop, mobile, or server central processing unit or chipset offered by INTEL^{®}, ADVANCED MICRO DEVICES^{®}, ARM^{®}, APPLE^{®}, TAIWAN SEMICONDUCTOR MANUFACTURING^{®}, QUALCOMM^{®}, or any other manufacturer. The computer system 74 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The computer system 74 and the sculpting software application 84 may use packetized communications. When the computer system 74 and the sculpting software application 84 communicates via the communications network, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The computer system 74, the sculpting software application 84, and the communications network may utilize any signaling standard. The networking environment may mostly use wired networks to interconnect the components of the Turcotte sculptor 50. However, the computer system 74, the sculpting software application 84, and the communications network may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The computer system 74, the sculpting software application 84, and the communications network may also utilize other standards, such as the I.E.E.E. 802 family of standards, the Industrial, Scientific, and Medical band of the electromagnetic spectrum, BLUETOOTH^{®}, low-power or near-field, and any other standard or value.

The sculpting software application 84 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for providing the sculpting software application 84, as the above paragraphs explain.

The diagrams, schematics, illustrations, and the like represent conceptual views or processes illustrating examples of cloud services malware detection. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system for machining a foam slab of foam material, comprising:
determining, by the computer system, an origin position associated with the foam slab of foam material and a 36-axes Turcotte sculptor;
identifying, by the computer system, a path to be cut within the foam slab of foam material; and
commanding, by the computer, the 36-axes Turcotte sculptor to machine the foam slab of foam material from the origin position according to the path.

2. The method of claim 1, further comprising sending actuation signals to any of thirty six (36) linear actuators associated with the 36-axes Turcotte sculptor.

3. The method of claim 1, further comprising identifying a wire linear speed associated with an electrical power applied to a wire.

4. The method of claim 3, further comprising moving the wire along the path according to the wire linear speed.

5. The method of claim 4, further comprising applying the electrical power to the wire as the wire moves along the path.

6. The method of claim 3, wherein the identifying of the wire linear speed comprises querying a database that associates the wire linear speed to the electrical power and to a material thickness associated with the foam slab of foam material.

7. A 36-axes Turcotte sculptor that machines a foam slab of foam material, comprising:
a frame;
a table sized to accept the foam slab of foam material;
a fence that when actuated aligns the foam slab of foam material with respect to the table;
an electrothermal hot-wire cutting system that when actuated melts a predetermined path within the foam slab of foam material;
thirty six (36) linear actuators, wherein a first group of the thirty six (36) linear actuators couples between the frame and table, a second group of the thirty six (36) linear actuators couples between the frame and the fence, and a third group of the thirty six (36) linear actuators couples between the frame and the electrothermal hot-wire cutting system; and
a computer system that electrically actuates a linear actuator of the thirty six (36) linear actuators as the electrothermal hot-wire cutting system melts the predetermined path within the foam slab of foam material.

8. A memory device storing instructions that, when executed by a computer system, perform operations that sculpt a foam slab of foam material, the operations comprising:
aligning the foam slab of foam material to an origin position associated with a table by actuating a first group of thirty six (36) linear actuators;
moving the table according to a path by actuating a second group of the thirty six (36) linear actuators; and
moving a hot-wire cutting system within the foam slab of foam material according to the path by actuating a third group of the thirty six (36) linear actuators.
